(19) United States
(12) Patent Application Publication
(10) Pub. No.: US 2005/0056063 A1
(43) Pub. Date: Mar. 17, 2005

(54) Merchandise lock bar system and method

(75) Inventors: Craig Zadak, Roscoe, IL (US); Joseph Gormley, Rockford, IL (US)

Correspondence Address: LEYDIG VOIT & MAYER, LTD, 6815 WEAVER ROAD, SUITE 300, ROCKFORD, IL, 61114-8018, US

(73) Assignee: Southern Imperial, Inc., Rockford, IL (US)

(21) Appl. No.: 10/663,601

(22) Filed: Sep. 16, 2003

(51) Int. Cl. E05B 65/00; E05B 73/00

(52) U.S. Cl. 70/57.1; 70/62

(57) ABSTRACT

The invention provides an improved lock bar system for enclosing at least one peg hook. The lock bar system can be in a merchandising display with the lock bar system including a peg hook support frame mounted to the merchandising display supporting a plurality of peg hooks in lateral spaced relation. The peg hooks include forward extending rods for supporting retail product, the peg hook support frame supporting a movable product retainer extending across forward ends of the plurality of peg hooks, the product retainer subject to a lock having a locked condition preventing removal of product from the peg hooks and an unlocked condition permitting removal of product from the peg hooks.

### FIELD OF THE INVENTION

The present invention relates generally lock bar, and, more particularly, relates to a merchandise lock bar that allows secure display of merchandise on merchandise hooks.

### BACKGROUND OF THE INVENTION

This invention relates to a locking bar system for merchandise. More particularly, it is for locking display merchandise that is placed on rods extending from a wall or pegboard. Merchandise is typically displayed to enable a customer to see merchandise and select items prior to purchasing. However, shoplifting is a known problem in retail settings, especially for high priced items.

It would be desirable to enable customers to view merchandise, even high-priced merchandise, on a display. Prior art methods of protecting merchandise include U.S. Pat. No. 5,027,622 to Hatch et al. (Jul. 2, 1991), which includes a locking device for attaching to individual peg hooks. Individually locking peg hooks, however, is inefficient in that store clerks must unlock each peg hook one at a time for customers. Moreover, by locking only the forward end of a peg hook, shop lifters can choose to remove the peg hook entirely to pilfer product. What is needed is an efficient and efficacious system and method for protecting product on peg hooks.

### BRIEF SUMMARY OF THE INVENTION

The invention provides an improved lock bar system for enclosing at least one peg hook. The lock bar system can be in a merchandising display with the lock bar system including a peg hook support frame mounted to the merchandising display supporting a plurality of peg hooks in lateral spaced relation. The peg hooks include forward extending rods for supporting retail product, the peg hook support frame supporting a movable product retainer extending across forward ends of the plurality of peg hooks, the product retainer subject to a lock having a locked condition preventing removal of product from the peg hooks and an unlocked condition permitting removal of product from the peg hooks.

Another embodiment is directed to a lock bar system for enclosing at least one peg hook protruding from a merchandising display. The lock bar system includes a frame configured to be attachable to a support, the frame including a peg hook support rear security rod and a peg hook support bar, a product retainer hingedly connected to the frame, the product retainer including a lower security rod and an upper security bar; and a lock mechanism coupled to the product retainer, the lock mechanism configured to prevent the product retainer from rotating by securing the product retainer to the frame. The product retainer protects product hanging from a plurality of peg hooks secured to the lock bar system by preventing the product from passing past the lower security rod and the upper security rod when the lock bar system is in a closed position. The frame is mounted to the merchandising display via mounting brackets on the merchandising display so that the brackets receive the frame via apertures for cantilevered support. The lock mechanism is a keyed lock configured to secure the product retainer to the frame. The upper security bar includes a label holder designed to hold labels for identifying product suspended on the peg hook.

### BRIEF DESCRIPTION OF THE DRAWINGS

FIG. 1 is a perspective view of one embodiment of the lock bar system constructed in accordance with the teachings of the present invention;

FIG. 2A is a cut-away perspective view of the lock bar system illustrating an open right side constructed in accordance with the teachings of the present invention.

FIG. 2B is a cut-away perspective view of the lock bar system illustrating a closed right side constructed in accordance with the teachings of the present invention.

FIG. 3 is a cut-away perspective view of the lock bar system illustrating an open left side constructed in accordance with the teachings of the present invention.

FIG. 4 is a cross section of a portion of the lock bar system illustrating an embodiment in accordance with the teachings of the present invention.

### DETAILED DESCRIPTION OF THE INVENTION

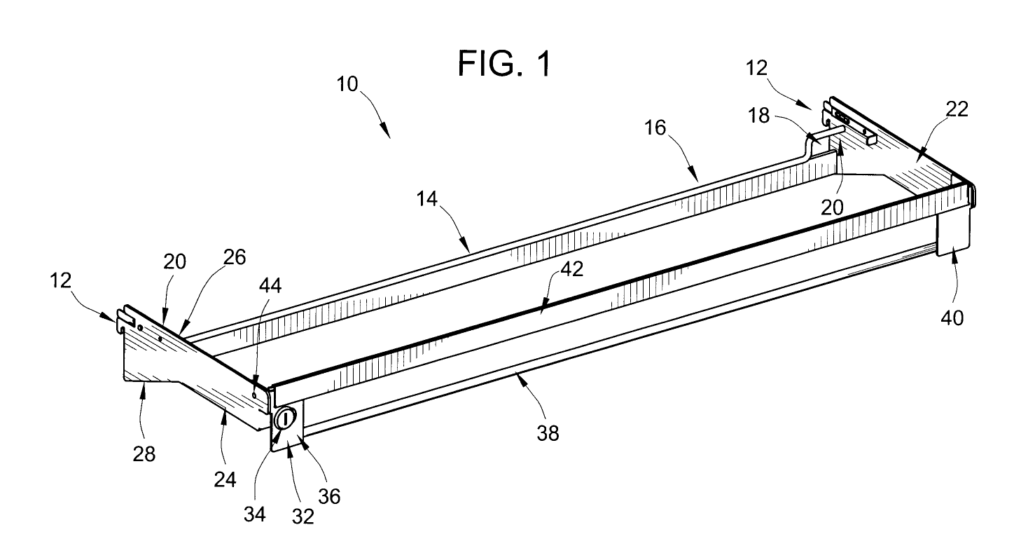

Turning now to the drawings, an embodiment of the present invention is depicted in FIG. 1. FIG. 1 illustrates a lock bar system 10 designed to be attached to a merchandising gondola or the like via hooks 12. Lock bar system 10 can be manufactured using a metal, such as steel or the like. The lock bar system 10 includes a rear security rod 14 and a peg hook support bar 16 for supporting peg hook backs. Peg hook backs for peg hooks or combination peg hook backs and peg hooks can be slidably inserted via entrance cavity 18, which is formed by two generally perpendicular bends at a first end 20 of peg hook support bar 16. The first end 20 is connected to first side wall 22.

Lock bar system 10 includes a second side wall 24. Both side walls 22 and 24 are formed with a level top edge 26 and a bottom edge with an angled rear edge portion 28 and a forward bottom level edge 30. The side walls 22 and 24 can be comprised of either panel type construction, steel rod construction or other appropriate construction that can be secured to mounting brackets and support the components of lock bar system 10, as will be appreciated by one of skill in the art with the benefit of the present disclosure. The side walls 22 and 24 are connected to peg hook support bar 16 and rear security rod 14, which together form a frame. The strength and the size of the frame, as design requirements dictate, can be manufactured to provide secure display according to the products to be displayed. Thus, for example, bulkier heavy product would mandate a strong steel construction, and lighter weight product would command a lighter weight construction, such as aluminum. If product to be displayed is a type mandating increased security due to expense of replacement, lock bar system 10 could be constructed of a strong steel regardless of the size and weight of the product.

Side wall 24 is shown coupled to locking mechanism 32, including a keyed mechanism 34. Keyed mechanism 34 could also be another type of locking mechanism, as one of skill in the art with the benefit of this disclosure will appreciate. Keyed mechanism 34 is attached to metal base plate 36 appropriately configured to receive a locking mechanism. Base plate 36 is coupled to a first end of forward lower security bar 38, which can be implemented as a rod connecting base plate 36 to base plate 40. Base plate 40 is shown coupled to a second end of forward lower security rod 38. Both base plate 36 and base plate 40 are configured as forward facing plates with a 90 degree rearward bent portion designed to be interior to sidewalls 24 and 22, respectively. The rearward bent portion is coupled to the frame using attachment means, such as bolt 44, to provide motility in the upward dimension. To prevent downward motion, sidewall 24 and sidewall 22 each have a forward inward bent portion that functions as a stop to support rearward bent portion of bases 36 and 40. Attached to both base plate 36 and base plate 40, along with rod 38, is upper security bar 42. Upper security bar 42 can be configured to avoid interruption with products displayed on peg hooks.

Upper security bar 42, lower security rod 38, key mechanism 34, and base plates 36 and 40 together form a product retaining structure that functions as a retainer to prevent product disposed on peg hooks sized for lock bar system 10 from being removed independent of an open lock bar position. Thus, product retaining structure has two modes or conditions of operation. In a first locked mode, product is prevented from exiting a peg hook because lower security rod 38 prevents forward motion of product suspended on the peg hook and upper security bar 42 prevents an upper portion of product suspended from the peg hook from sliding forward on the peg hook. In an unlocked mode, product can be removed by lifting the product retaining structure above the exiting portion of the peg hook.

Lock bar system 10 is shown in closed position. That is to say, a hinge mechanism 44 is disposed on each side wall 22 and 24 that permits store clerks and authorized personnel with an appropriate security vehicle, such as a key, combination, code or the like to lift the combination of lower security rod 38, upper security bar 42 and base plates 36 and 40, including keyed mechanism 32.

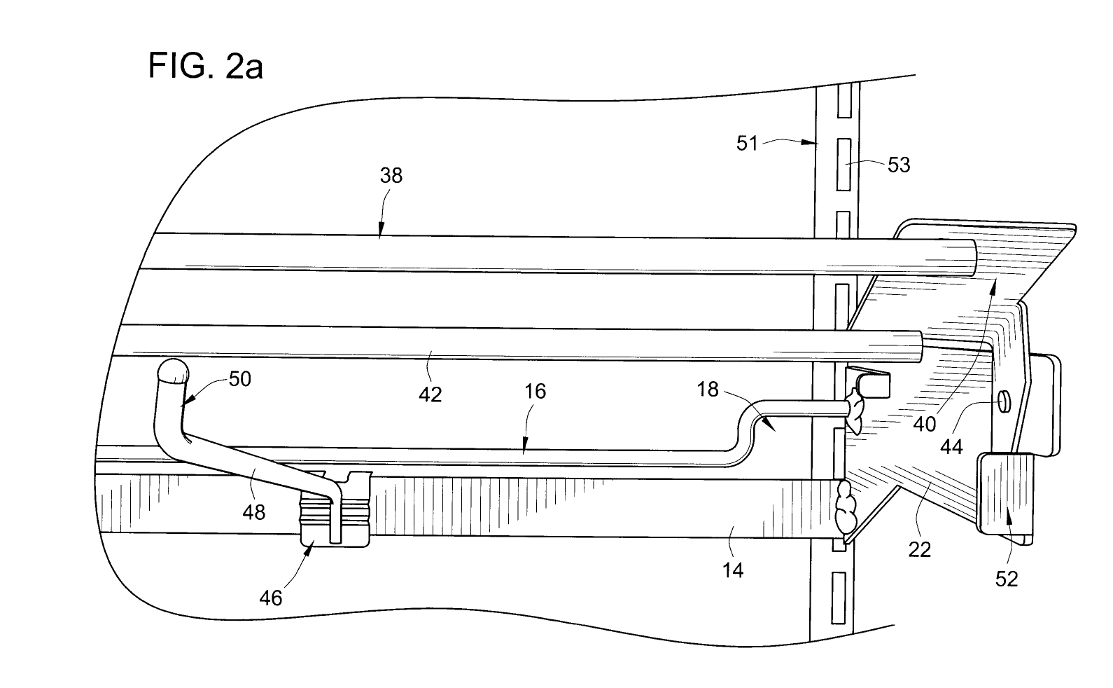

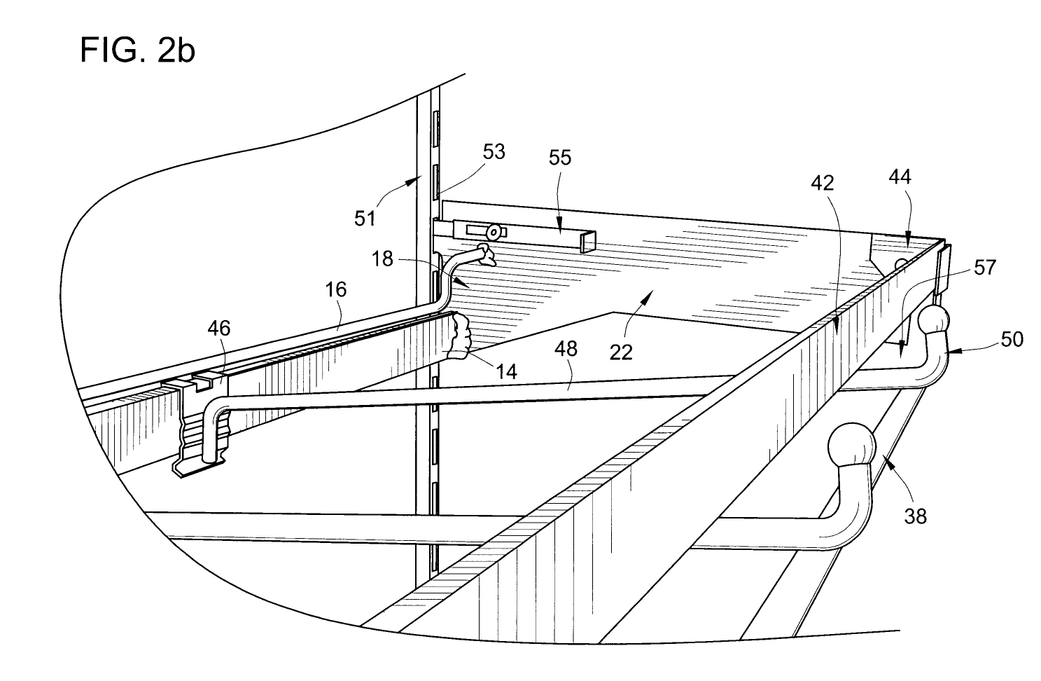

Referring now to FIG. 2A, lock bar system 10 is shown in open position with a peg hook back 46 and peg hook 48 in place. With lock bar system 10 in open position, store clerks are able to place products over bent free end 50 of peg hook 48 and any other peg hooks disposed below peg hook support bar 16. As shown, lower security rod 38 and upper security bar 42 hingedly lift above peg hook 48. Base plate 40 is shown lifting with security rod 38 and bar 42. Open lock bar system 10 reveals stop 52, which butts against base plate 40 when lock bar system 10 is in a closed position. Stop 52 is formed by the forward inward bent portion of each side wall 24 and 22. FIG. 2 also shows mounting bracket 51 with a plurality of apertures 53. Lock bar system 10 is supported on a merchandising display via a cantilever force of hooks on the frame inserted into apertures 53.

FIG. 2B illustrates lock bar system 10 in a closed position with peg hook back 46 and peg hook 48 in place. A peg hook 48 appropriate for the invention includes a rod extending from peg hook back 46, as shown, peg hook 48 includes an elongated rod with a forward end 57 that includes a free end 50 of the rod that is bent at an angle such that the bent free end protrudes between upper security bar 42 and lower security rod 38, and upward in front of upper security bar 42. Hanging products on peg hook 48 situated behind bar 42 are prevented from removal by both upper bar 42 and lower bar 38.

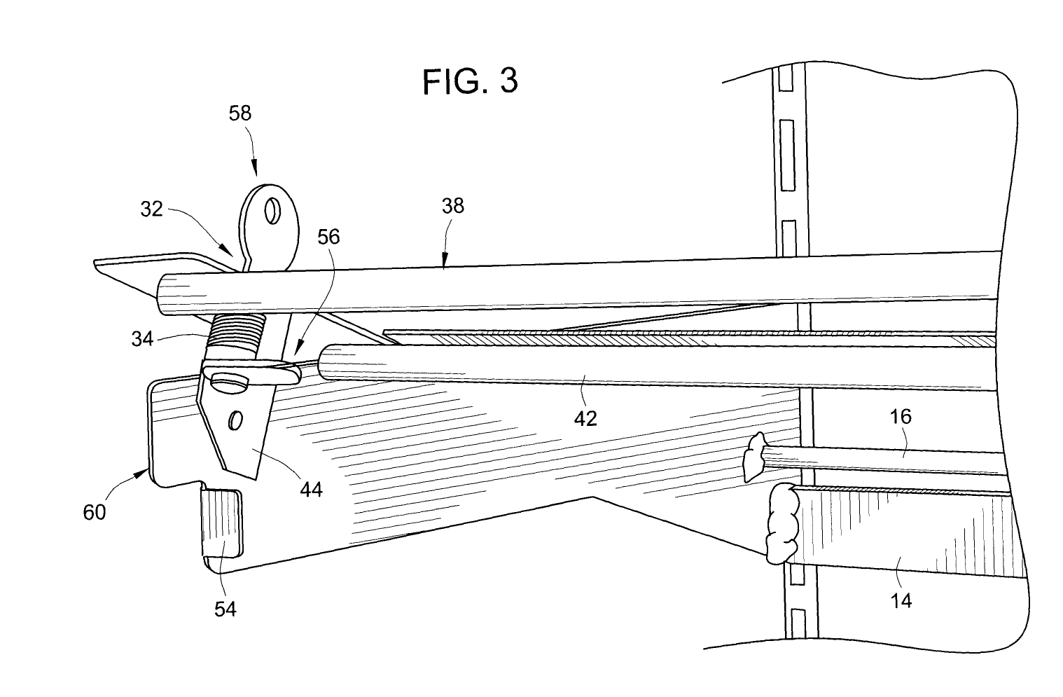

Referring now to FIG. 3, lock bar system 10 is shown in an open position with keyed mechanism 32 shown in further detail. More specifically, FIG. 3 shows stop 54, which functions, like stop 52, to butt against base plate 36 when lock bar system 10 is in a closed position. Moreover, stop 52 further functions as part of locking mechanism 32 by functioning as a keeper plate for securing latch member 56. That is to say stop 54 cooperates with locking mechanism 32 to lock the combination of upper security bar 42 and lower security rod 38 in its closed position. A key 58 activates locking mechanism 32 to urge latch 56 to rotate behind stop 54 to retain lock bar system 10 in a closed position. Lowering lower security rod 38 and upper security bar 42 encloses any peg hooks holding merchandise in need of security.

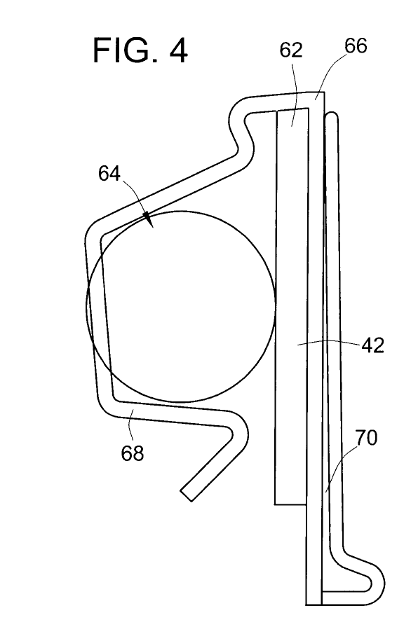

Referring now to FIG. 4, a cross section of upper security bar 42 is shown to illustrate that bar 42 can be configured to receive a label holder such as a label holder for a flat faced shelf channel. Specifically, bar 42 includes security rod 64 connected to front bar 62. A label holder 66 is shown positioned over both front bar 62 and rod 64. Accordingly, upper security bar 42 can be configured to have a dual purpose of both providing a channel for label holders and for enclosing products, such as products associated with labels in the label holders. As one of skill in the art will appreciate, upper security bar 42 can be configured to receive additional types of label holders. Further label holder 66 can be extruded plastic, such as an appropriate plastic material such as polyvinyl chloride, co-extruded polyvinyl chloride, butryrate, provista or acrylonitrile butadiene styrene (ABS). The label holder 66 can be approximately between 1 and 1½ inches in height. To install a label holder onto bar 42, a label holder back 68 must be resilient enough to hingedly stretch over rod 64 while front label panels 70 abut the face of bar 62.

Another embodiment of the invention is directed to a method for securing product in a merchandising display. More specifically, the method provides for installing a plurality of peg hooks on peg hook support bar 14 with the peg hook support bar supported by mounting brackets 51 connected to the merchandising display. A store clerk then can place product on the peg hooks. The method then provides for securing a product retaining structure, such as a product retaining structure including upper security bar 42 and lower security rod 38, the upper security bar 42 and the lower security rod 38 in vertical space relation and normal to the forward end 57 of the peg hooks 48 when in a closed mode. In one embodiment, the method also includes removing product by unlocking a lock mechanism coupled to the product retaining structure and lifting the product retaining structure upwardly such that the upper security bar and the lower security rod are suspended above the peg hooks to allow product to be removed.

In one embodiment of the method installing the plurality of peg hooks includes placing each peg hook back 46 onto the peg hook support bar 14 via an entrance cavity 18 between the peg hook support bar 14 and peg hook security rod 16 when the product retaining structure is in an open mode.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A lock bar system for enclosing at least one peg hook protruding from a merchandising display, the lock bar system comprising:
a frame configured to be attachable to a support, the frame including a peg hook support rear security rod and a peg hook support bar;
a product retainer hingedly connected to the frame, the product retainer including a lower security rod and an upper security bar; and
a lock mechanism coupled to the product retainer, the lock mechanism configured to prevent the product retainer from rotating by securing the product retainer to the frame.

2. The lock bar system of claim 1 wherein the product retainer is configured to protect product hanging from a plurality of peg hooks secured to the lock bar system by preventing the product from passing past the lower security rod and the upper security rod when the lock bar system is in a closed position.

3. The lock bar system of claim 1 wherein the frame is mounted to the merchandising display via mounting brackets on the merchandising display, the mounting brackets configured to receive the frame via apertures for cantilevered support.

4. The lock bar system of claim 1 wherein the lock mechanism is a keyed lock configured to secure the product retainer to the frame.

5. The lock bar system of claim 1 wherein the upper security bar includes a label holder and labels for identifying product suspended on the peg hook.

6. A lock bar system in a merchandising display, the lock bar system comprising: a peg hook support frame mounted to the merchandising display supporting a plurality of peg hooks in lateral spaced relation, the peg hooks including forward extending rods for supporting retail product, the peg hook support frame supporting a movable product retainer extending across forward ends of the plurality of peg hooks, the product retainer subject to a lock having a locked condition preventing removal of product from the peg hooks and an unlocked condition permitting removal of product from the peg hooks.

7. The lock bar system of claim 6 wherein the movable product retainer is hingedly connected to the peg hook support frame, an upward movement when the lock is in an unlocked condition moving the product retainer above the plurality of peg hooks, permitting removal of product.

8. The lock bar system of claim 6 wherein the peg hook support frame includes:
a peg hook support bar extending laterally between mounting brackets; and
a peg hook retaining rod spaced vertically from the peg hook support bar, the peg hook retaining rod preventing removal of any one of the plurality of peg hooks while the lock bar system is in a locked condition.

9. The lock bar system of claim 8 wherein the peg hook support bar includes a bar configured to hold peg hook backs; and the retaining rod is spaced to prevent removal of peg hook backs except via an entrance cavity formed at an end of the retaining rod, the cavity allowing upward movement of a peg hook back.

10. The lock bar system of claim 8 wherein the movable product retainer includes an upper security bar and a lower security rod, the upper security bar including a retainer bar configured to hold one or more label holders.

11. A lock bar system for securing product in a merchandising display, comprising:
a vertical support including at least a pair of mounting brackets;
a peg hook support bar extending laterally between the mounting brackets;
a peg hook rod extending laterally between the mounting brackets in vertical space relation to the peg hook support bar, the peg hook rod capable of preventing removal of a plurality of peg hooks supported by the support bar;
a product retaining structure supported by the mounting brackets in space relation to the peg hook support bar proximate a forward end of the peg hooks, the product retaining structure configured to receive one or more label holders for product identification; and
a lock mechanism having locked and unlocked modes, product being removable from the peg hooks in the unlocked mode and being non-removable on the peg hooks by the product retaining bar in the locked mode.

12. The lock bar system of claim 11 wherein the product retaining structure is hingedly connected to the peg hook support frame.

13. The lock bar system of claim 11 wherein the product retaining structure includes a forward upper security bar and a lower security rod.

14. The lock bar system of claim 13 wherein the upper security bar is above the forward end of the peg hooks when the lock bar system is in the locked mode and the lower security rod is below the forward end of the peg hooks when the lock bar security system is in the locked mode.

15. The lock bar system of claim 13 wherein the upper security bar and the lower security rod are rotated above the forward end of the peg hooks when the lock bar security system is in the open mode.

16. A method for securing product in a merchandising display, the method comprising:
installing a plurality of peg hooks on a peg hook support bar, the peg hook support bar supported by mounting brackets connected to the merchandising display;
placing the product on one or more of the peg hooks; and
securing a product retaining structure supported by the mounting brackets, the product retaining structure proximate a forward end of the peg hooks, the product retaining structure including an upper security bar and a lower security rod, the upper security bar and the lower security rod in vertical space relation and normal to the forward end of the peg hooks when in a closed mode.

17. The method of claim 16 further comprising:
when product is to be removed, unlocking a lock mechanism coupled to the product retaining structure; and
lifting the product retaining structure upwardly such that the upper security bar and the lower security rod are suspended above the peg hooks to allow the product to be removed.

18. The method of claim 16 wherein installing the plurality of peg hooks includes placing each peg hook back onto the peg hook support bar via an entrance cavity between the peg hook support bar and a peg hook security rod in vertical space relation to the peg hook support bar, the entrance cavity permitting installation of one or more peg hook backs coupled to peg hooks only when the product retaining structure is in an open mode.

19. The method of claim 16 wherein the peg hook support bar and the peg hook security rod are portions of a frame supported by the mounting brackets, the product retaining structure hingedly connected to the frame.

20. The method of claim 16 wherein the securing includes having the product retaining structure in the closed mode and locking a lock mechanism coupled to the product retaining structure, the locking mechanism securing the product retaining structure to the frame in the closed mode.

21. The method of claim 16 wherein the product retaining structure includes a bar configured to enable label holders to be inserted thereon.

22. A combination comprising a merchandising display for displaying product on a plurality of peg hooks and a lock bar system including support means for supporting said peg hooks and securing means for securing said product, said securing means being attached to said support means for supporting said peg hooks, said securing means extending forwardly from said support means and enclosing a forward end of said peg hooks when said securing means is in a closed mode.

23. The combination of claim 22 wherein the support means includes first and second vertically spaced and generally horizontally extending rear members, said first rear member configured to support peg hooks placed on said first rear member via an entrance cavity formed between said first and send rear members, said second rear member comprising a rod for preventing removal of the peg hooks when said lock bar system is in the closed mode.

24. The combination of claim 22 wherein said support means and said securing means are coupled to said merchandising display via mounting brackets including apertures for receiving said support means and said securing means in cantilevered support.

25. The combination of claim 22 wherein said securing means includes first and second vertically spaced and generally horizontally extending front members in horizontal relation to said first and second rear members when in the closed mode.
